(19) United States
(12) Patent Application Publication
(10) Pub. No.: US 2015/0140532 A1
(43) Pub. Date: May 21, 2015

(54) EXERCISE SYSTEMS

(71) Applicant: Nancy Beth Whitney, Otis, OR (US)

(72) Inventor: Nancy Beth Whitney, Otis, OR (US)

(21) Appl. No.: 14/269,553

(22) Filed: May 5, 2014

Related U.S. Application Data
(60) Provisional application No. 61/906,261, filed on Nov. 19, 2013.

(51) Int. Cl. G09B 19/00

(52) U.S. Cl. CPC G09B 19/003; G09B 19/0092
USPC 434/247; 434/127

(57) ABSTRACT

Disclosed exercise systems can provide a user with a plurality of exercise instructions, a plurality of cooking instructions, and a plurality of integration instructions correlating the exercise instructions with the cooking instructions. In this way, disclosed exercise systems can provide a user a simple, step-by-step method of performing exercises or physical activity while cooking and preparing food. Such exercise systems can be beneficial in terms of planning exercise for a user, as well as avoiding the need to carve out a specific time during the day to devote to exercise. Such exercise systems can be in the form of a card or set of cards, with each card containing cooking instructions for a recipe for a different food item, and different sequence or combinations of exercises to perform while cooking the food item.

### RELATED APPLICATION

This application claims priority to U.S. Provisional Patent Application Ser. No. 61/906,261, which was filed on Nov. 19, 2013, the complete disclosure of which is hereby incorporated by reference.

### FIELD

The present disclosure relates generally to exercise systems, such as exercise systems that provide instructions for performing exercises while preparing food.

### BACKGROUND

The benefits of a healthy lifestyle (e.g., eating well and performing physical activity, or exercise, on a regular basis) are well-known, yet many people struggle to find time for physical activity in their busy and hectic lives. Numerous health-focused lifestyle resources exist, including exercise books, healthy eating cookbooks, exercise cards, fitness games, and the like, but these require that users carve out time from their daily routines in order to devote to such books and activities. Many people do not have time to strictly devote to physical activity, and therefore fail to perform physical activity altogether. Others may lack the motivation or planning skills to incorporate exercise into their daily routines, and thus also do not exercise regularly.

Some fitness enthusiasts have suggested generally that one can perform exercises in the kitchen, or while cooking, but such suggestions are not specific enough for integration into one's daily routine without planning, arrangement, and scheduling of one's time, and thus are not readily and practically performed. There thus remains a need for a system that can provide for integration of physical activity or exercise within one's daily routine.

### SUMMARY

Presently disclosed embodiments of exercise systems can provide for integration of physical activity within one's daily routine. In one embodiment of an exercise system according to the present disclosure, the exercise system can include a first display displaying a plurality of exercise instructions, a second display displaying a plurality of cooking instructions, and a plurality of integration instructions displayed by at least one of the first display and the second display, wherein the integration instructions instruct as to when to perform each of the plurality of exercise instructions with respect to a respective one or more of the plurality of cooking instructions.

In some embodiments, the first display can be a card with the exercise instructions printed thereon, or a set of cards, where the plurality of exercise instructions is a respective set of the plurality of exercise instructions, and each respective set of the plurality of exercise instructions can be printed on a respective card of the set of cards. Similarly, in some embodiments, the second display can be a card with the cooking instructions printed thereon, or a set of cards, where the plurality of cooking instructions is a respective set of the plurality of cooking instructions, and each respective set of the plurality of cooking instructions can be printed on a respective card of the set of cards.

In some embodiments, a card of the presently disclosed exercise systems can include a front surface and a rear surface, wherein the first display and the second display are printed on the front surface of the card. The rear surface of the card can contain recipe information printed thereon, such as one or more of ingredients, serving size, nutritional information, yield, points for a weight loss point system, cooking time, total time, and preparation time.

Presently disclosed exercise systems can display or provide instructions and information on a wide variety of formats and media. For example, the first display and/or the second display can be provided on one or more of a card (or a portion thereof), a page (or a portion thereof), a sheet (or a portion thereof), a poster (or a portion thereof), a book (or a portion thereof), a binder for a portion thereof), a digital file for a portion thereof), a computer monitor, a CD, DVD, or other storage media, a mobile phone, and an app for a mobile device.

Embodiments of the presently disclosed exercise systems can be configured to send a reminder to a user to utilize the exercise system, can be configured to automatically generate a shopping list corresponding to the plurality of cooking instructions, and/or can be integrated with a calendar.

Exercise systems can be a set of a plurality of cards, each card comprising a respective first display directed to a respective set of exercise instructions and a respective second display directed to a respective set of cooking instructions, where each respective set of cooking instructions can be different from every other respective set of cooking instructions. Furthermore, exercise systems can be a plurality of sets of cards. In some embodiments, each of the sets of cards can be directed to one of a plurality of different themes such as Breakfast, Lunch, Dinner, Snacks, Breads, Drinks, Vegan, Vegetarian, Entrees, Gluten-Free, Dairy-Free, Wheat-Free, Sugar-Free, Fat-Free, Reduced Fat, Reduced Sodium, Reduced Cholesterol, Low Fat, Low Calorie, Light, Comfort Food, Pasta, Stir-Fry, Meat and Fish, Rice Dishes, Noodle Dishes, Chinese, Indian, That, Italian, American, Easy, Moderate, Strenuous, Arms, Legs, Back, Abs, Core Strength, Stretching, and/or Yoga.

Methods of providing instructions are also disclosed. In one example, a method of providing instructions can include providing a first cooking instruction, providing a first exercise instruction, and providing a first integration instruction, wherein the first integration instruction instructs as to when to perform the first exercise instruction with respect to the first cooking instruction. One or more of the providing the first cooking instruction, the providing the first exercise instruction, and the providing the first integration instruction can include providing the same on a printed and/or digital medium. Further, a plurality of cooking instructions (performance of which results in completion of cooking a food item), a plurality of exercise instructions, and/or a plurality of integration instructions can be provided in some methods.

### BRIEF DESCRIPTION OF THE DRAWINGS

FIG. 1 is a diagram schematically representing illustrative, non-exclusive examples of exercise systems according to the present disclosure.

FIG. 2 is a diagram schematically representing illustrative, non-exclusive examples of exercise systems according to the present disclosure.

FIG. 3 is a diagram schematically representing illustrative, non-exclusive examples of exercise systems according to the present disclosure.

FIG. 4 is a diagram schematically representing illustrative, non-exclusive examples of exercise systems according to the present disclosure.

FIG. 5 is a schematic block diagram representing an illustrative, non-exclusive example of a method of providing instructions using the exercise systems of the present disclosure.

FIG. 6 is a front elevation view of an illustrative, non-exclusive example of an exercise system according to the present disclosure.

FIG. 7 is a rear elevation view of the exercise system of FIG. 6.

FIG. 8 is a schematic block diagram of a method of using the exercise systems of the present disclosure.

### DESCRIPTION

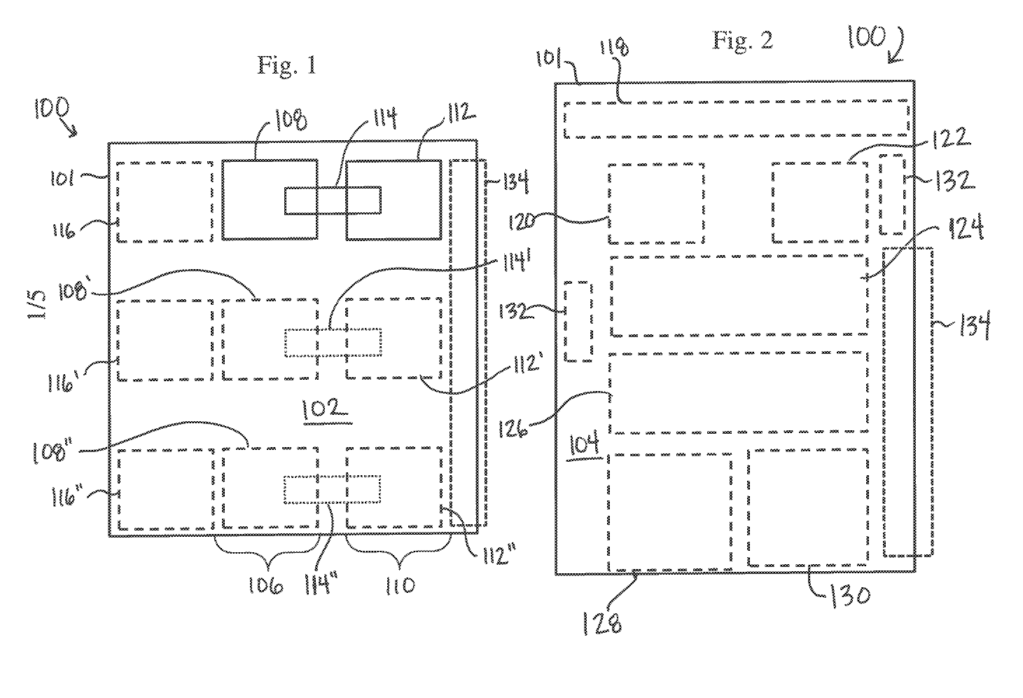

FIGS. 1 and 2 show schematic representations of embodiments of exercise systems according to the present disclosure. Presently disclosed exercise systems can lake any suitable form, whether physically or digitally presented, and can generally display information to a user, such as a plurality of physical activity, or exercise, instructions and a plurality of cooking, or food preparation, instructions, The exercise instructions can be correlated with and integrated with the cooking instructions, such that the exercise instructions are chronologically related to the cooking instructions. For example, presently disclosed exercise systems can include one or more integration instructions that teach a user how and when to integrate exercise instructions with the cooking instructions. In this way, the presently disclosed exercise systems can provide instructions to a user to perforin physical activities during food preparation, on a step-by-step basis, without requiring planning or arrangement of such steps by the user. A user can thus perform exercises at the same time he or she is preparing a meal, and thus the user need not carve out time in his or her daily schedule to devote to exercise alone.

In some embodiments, exercise systems of the present disclosure may take the form of a card (e.g., apiece of cardstock with information and/or instructions printed on one or both surfaces), or a set of cards, with exercise and cooking instructions printed thereon. For example, FIGS. 1 and 2 show examples of an exercise system 100 that includes a card 101 having a front surface 102 (FIG. 1) and a rear surface 104 (FIG. 2). As seen in FIG. 1, front surface 102 can include a first display 106 displaying a plurality of exercise instructions 108. As used herein, the term “display” refers to any physical or digital medium for displaying information, or portions thereof. For example, first display 106 may be a surface of a card, a portion of a surface of a card, a page in a book, a portion of a page in a book, a page in a digital file, a digital image, a screen view on a computer, and/or a screen view on a mobile phone. As used in FIG. 1, first display 106 is shown as a portion of the front surface 102 of card 101 (e.g., first display 106 may be a column in a table printed on the card 101), but first display 106 is not limited to such.

While the exercise system 100 in FIG. 1 shows three exercise instructions 108, 108′, and 108″, any number of exercise instructions 108 can be displayed via the first display 106, such as at least 1 exercise instruction 108, at least two exercise instructions 108, at least three exercise instructions 108, at least four, at least five, at least six, at least seven, at least eight, at least nine, and/or ten or more exercise instructions 108. Generally, firsy display 106 can include between one and fifty exercise instructions 108. Exercise instructions 108 can include instructions as to how to perform a given physical activity or exercise, the time one should spend doing the physical activity, and/or the number of repetitions and sets for a given exercise, A given first display 106 can include exercise instructions 108 for a plurality of different exercises or physical activities. Such physical activities can include stretching, movement, rotation, bending, strengthening exercises, cardiovascular exercises, and etc., as will be apparent to one of ordinary skill in the art.

Front surface 102 can also include a second display 110 displaying a plurality of cooking instructions 112. As with first display 106, second display 110 may be a surface of a card, a portion of a surface of a card, a page in a book, a portion of a page in a book, a page in a digital file, a digital image, a screen view on a computer, and/or a screen view on a mobile phone. As used in FIG. 1, second display 110 is shown as a portion of the front surface 102 of card 101 (e.g., second display 110 may be a column in a (able printed on the card 101), but second display 110 is not limited to such.

While the illustrated exercise system 100 shows three cooking instructions 112, 112′, and 112″, any number of cooking instructions 112 can be displayed via second display 110, such as at least one cooking instruction 112, at least two cooking instructions 112, at least three cooking instructions 112, at least four, at least five, at least six, at least seven, at least eight, at least nine, and/or ten or more cooking instructions 112. Generally, second display 110 can include between one and fifty cooking instructions 112. Cooking instructions 112 can include instructions as to how to prepare a food item, and can include preparation steps and cooking steps, so that following the plurality of cooking instructions 112 in a given second display 110 will result in the completion of a food item. Examples of cooking instructions 112 that may be included in a given second display 110 include instructions 112 such as preheating an oven or pan, bringing a pot of water to a boil, cutting vegetables or other ingredients (e.g., chopping, dicing, slicing, etc.), measuring ingredients, adding ingredients, mixing ingredients, stirring ingredients, heating ingredients, and any other steps as may be necessary or recommended for preparation of a given food item. Cooking instructions 112 may also include timing components, such as instructions as to how long to bake or cook an item or mixture of items.

Exercise systems 100 may also include a plurality of integration instructions 114 that instruct a user how to integrate the exercise instructions 108 and the cooking instructions 112 together, so that the user is able to perform the exercise instructions 108 at appropriate times during performance of the cooking instructions 112 by following step-by-step instructions, and without requiring specific planning or time-mapping by the user. The integration instructions 114 can instruct as to when to perform each of the plurality of exercise instructions 108 with respect to a respective one or more of the cooking instructions 112. In this way, a user following the instructions provided by an embodiment of the disclosed exercise systems 100 can accomplish the preparation of a food item (e.g., a dinner entrée) and also performance of physical activity during the same time period.

Integration instructions 114 may be interspersed with the exercise instructions 108 and/or may be interspersed with the cooking instructions 112. For example, an integration instruction 114 may be interspersed with cooking instructions 112 within the second display 110, and/or may be interspersed within the exercise instructions 108 within the first display 106. In some embodiments, each respective cooking instruction 112 may have a corresponding respective integration instruction 114. In other embodiments, two or more cooking instructions 112 may be correlated with a single respective integration instruction 114. Likewise, in some embodiments, each respective exercise instruction 108 may have a corresponding respective integration instruction 114. In other embodiments, two or more exercise instructions 108 may be correlated with a single respective integration instruction 114. In some embodiments, all of the integration instructions 114 are provided in the second display 110 with the cooking instructions 112. In other embodiments, the integration instructions 114 may be provided entirely in the first display 106 with the exercise instructions 108. In yet other embodiments, there may be one or more integration instructions 114 in each of the first display 106 and second display 110. Alternatively, the integration instructions 114 may be provided separately from the cooking instructions 112 and exercise instructions 108.

Integration instructions 114 can refer to one or more cooking instructions 112, and/or integration instructions 114 may simply be listed among the cooking instructions 112 and/or exercise instructions 108 so as to be performed chronologically as listed. For example, a specific example of a cooking instruction 112 may instruct a user to brown sausage for about four minutes. A specific example of a correlated integration instruction 114 may instruct a user to perform an exercise while the sausage cooks. Integration instructions 114 may instruct a user to perform a single exercise instruction 108 or two or more exercise instructions 108. For example, in one specific embodiment, the cooking instructions 112 may result in the preparation of a dish that must be baked for a significant period of time, such as 30 minutes or more, and in some embodiments, a plurality of exercise instructions 108 may be performed during this significant period of time. A specific example of an exercise system 100 may include a cooking instruction 112 that instructs the user to hake an item for a given time period (e.g., one hour). The corresponding integration instruction 114 may instruct the user to perform a plurality of exercise instructions 108 during that one hour time period.

Disclosed exercise systems 100 may also include one or more images (e.g., pictures, photographs, depictions, or illustrations) 116. For example, images 116 may show the user a depiction of the exercise or physical activity being instructed by the exercise instructions 108. For example, a specific exercise instruction 108 may instruct a user to rotate their arms while holding their elbows in a set position. A corresponding image 116 may show a drawing of the desired arm position, a photograph of someone performing the exercise, and/or otherwise may provide an image that helps the user visualize the exercise being described in the exercise instructions 108. Exercise systems 100 may include one or more images 116 for each exercise instruction 108 provided. In other embodiments, fewer images 116 may be included. While FIG. 1 shows the front surface 102 of a card 101 having three images 116, 116′, and 116″, any number of images 116 may be included. In some embodiments, one or more images 116 may be positioned alongside the exercise instructions 108, cooking instructions 112, and/or integration instructions 114. For example, images 116 may be provided in a column of a table printed on card 101 that also includes the first display 106 and second display 110 as described above.

FIG. 2 shows another aspect or view of the exercise systems 100 of FIG. 1, FIG. 2 illustrates the rear, or opposite surface 104 of the card 101 shown in FIG. 1. The rear surface 104 may include information related to the exercise instructions 108 and/or cooking instructions 112 provided on the front surface 102 of card 101. In some embodiments, the rear surface 104 may provide information regarding a food item that the cooking instructions 112 on the front surface 102 instruct a user to prepare. For example, if the cooking instructions 112 on the front surface 102 of card 101 instruct a user to prepare a lasagna dish (the food item), the rear surface 104 may include information about the lasagna dish (or any other food item resulting from the cooking instructions 112 on the respective card 101).

For example, the rear surface 104 may have information and/or pictures printed thereon concerning the food item (e.g., recipe information), such as the food item title 118, a photograph or drawing 120 of the food item, information 122 regarding options, cooking time, preparation time, total time, points for a weight loss food point system, and/or other notes, ingredients and quantities 124, nutritional information 126, percentage of daily value of vitamins and minerals 128, and/or serving size and recipe yield information 130. Any or all of these pieces of information may be included for a given food item on a card 101. Of course, the format and layout of such information is variable.

Front surface 102 and/or rear surface 104 of the exercise systems 100 may include a color-coded portion 134 in some embodiments. Color-coded portion 134 may be a portion of the card 101 that is colored a particular color to convey information about the particular card 101 (e.g., information regarding the type of exercise or food item included on the card 101). In some embodiments, color-coded portion 134 may be an area or portion of the card 101. In other embodiments, color-coded portion 134 may be the entire background surface of card 101 (e.g., the entire front surface 102 and/or the entire back surface 104 may have a particular background color that conveys information to a user). In some embodiments, color-coded portion 134 may extend off the edge of card 101 (e.g., color-coded portion 134 can be a tab or other marker adhesively or otherwise affixed to card 101, and may extend beyond the border or edge of card 101 so that the color-coded portions 134 are visible when a plurality of cards 101 are included in an exercise system (e.g., in an exercise system 100 consisting of a plurality of cards 101 or a plurality of cards or pages within a binder, for example, color-coded portion 134 can be tabs on some or all of the cards or pages that are visible to the user)).

Exercise systems 100 of the present disclosure may be configured to be easily accessible to a user during use. For example, card 101 may be magnetic so that it can be affixed to any number of magnetic surfaces in a typical kitchen or other household area, for easy reference by a user while performing the instructions 108, 112, 114 of the exercise system 100. In some embodiments, the entire card 101 may itself be magnetic. In other embodiments, one or more magnets 132 may be placed or fixed to any portion of the card 101. For example, a strip of adhesive-backed magnetic tape may be affixed to the card 101. In other embodiments, a stand or book-holder can be used to hold or the display the card 101 or other medium for easy access by a user and easy visibility during use. Alternatively, the instructions 108, 112, 114 can be displayed on a screen, such as on a mobile device (e.g., a mobile phone or tablet), computer screen, or other display.

While FIGS. 1 and 2 show embodiments of a card 101 having cooking and exercise instructions displayed on the front surface 102 and food item information displayed on the rear surface 104, the terms “front” and “rear” are not meant to be limiting, but merely meant to establish that the card 101 can have information printed on two surfaces. The food item information shown in FIG. 2 can just as easily be displayed on the “front” surface of card 101, and the exercise and cooking instructions shown in FIG. 1 can be displayed on the “rear” surface of card 101. In other words, the location of the displays is not relevant to the presently disclosed exercise systems 100, other than that they may include a card 101 with printing on both sides, and/or may display the relevant information in any way that is easily accessible by a user.

While FIGS. 1 and 2 show embodiments of exercise systems 100 utilizing one or more cards 101, the same information and instructions can be displayed on a number of different media and/or in any variety of formats. For example, instead of or in addition to, card 101, exercise systems 100 can display information and/or instructions on a portion of a card, on a page or a portion of a page, on a sheet or a portion of a sheet, on a poster or a portion of a poster, in a book or a portion of a book, in a binder or a portion of a binder (e.g., pages or cards may be hole-punched in order to be stored in a binder and/or cards or pages may be stored in plastic sheets within a binder, with or without other information in the same binder), in a digital file or a portion of a digital file, on a CD, DVD, or other storage device, on a computer monitor, on a mobile phone or other portable electronic device, via a web site or online subscription, and/or via an app for a mobile device (such as a phone or tablet). In other words, first display 106 and second display 110 can be incorporated in any of the above-mentioned media formats or devices. Cards and/or pages or other paper-based media can be laminated or otherwise reinforced, if desired. Exercise systems 100 of the present disclosure can take any suitable form that enables displaying cooking and exercise instructions together to a user, in a way that the exercise instructions are integrated with the cooking instructions in a step-by-step manner (e.g., using integration instructions), so that a user can perform the physical activities instructed while also preparing food.

In some embodiments, disclosed exercise systems 100 can be integrated with a user's calendar, such as an electronic calendar associated with a user's computer, electronic device, mobile phone, or the like, so as to send automatic reminders to utilize the system. In some embodiments, disclosed exercise systems 100 can automatically generate a shopping list corresponding to the plurality of cooking instructions 112 for a given selection. For example, in the context of an exercise system taking the form of a mobile app or computer program, a user can select one or more recipes from a number of different options. For example, if an exercise system according to the present disclosure has 25 different recipe options (e.g., sets of cooking instructions and corresponding exercise and integration instructions to prepare 25 different food items), a user can select a different recipe for one or more days in a given week. The exercise system can then automatically generate a shopping list for the one or more recipes selected, and can, in some embodiments, send reminders to the user on the day the recipe was assigned to.

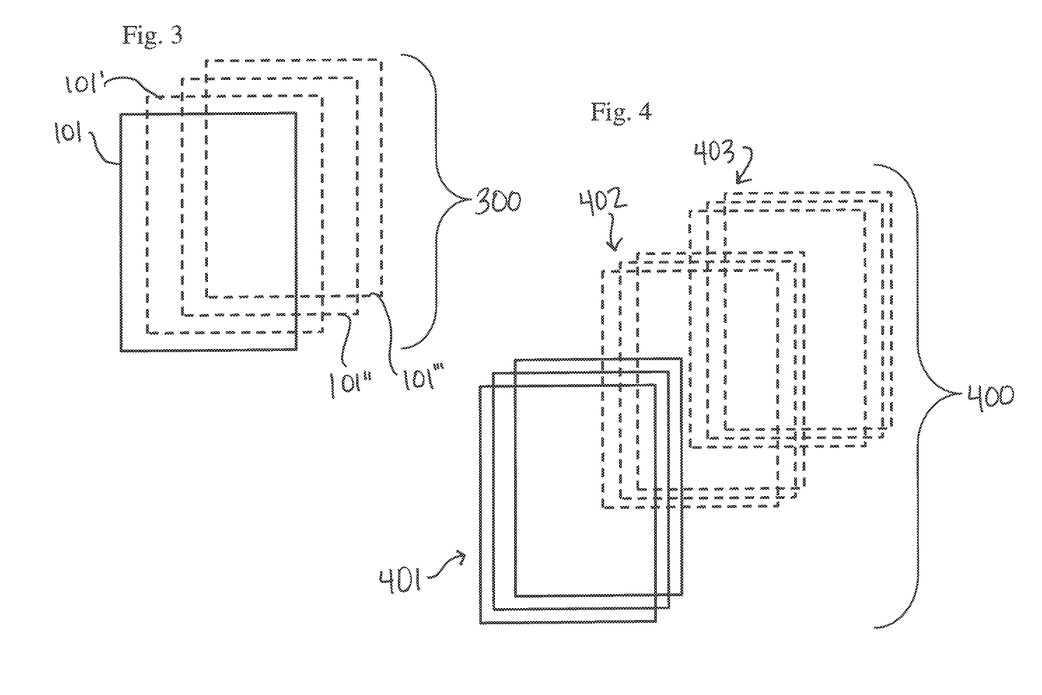

FIG. 3 shows exercise systems 300, which are examples of the exercise systems 100 of FIGS. 1 and 2, that comprise a set of a plurality of cards (e.g., first card 101, second card 101′, third card 101″, fourth card 101′″ and so on), each card 101 comprising a respective first display directed to a respective set of exercise instructions and a respective second display directed to a respective set of cooking instructions, each respective set of cooking instructions being different from every other respective set of cooking instructions. For example, card 101 may include cooking instructions for preparing a first food item (e.g., lasagna), card 101′ may include cooking instructions for preparing a second food item (e.g., fried rice), card 101″ may include cooking instructions for preparing a third food item (e.g., chicken curry), and so on. Thus, the cooking instructions on each respective card 101, 101′, etc., may be different from the cooking instructions on each other card 101, 101′, etc., so that the food item is different on each card in a given set of cards. Exercise systems 300 may include airy number of cards 101. For example, an exercise system may include at least one card 101, at least 5 cards 101, at least 10 cards 101, at least 20 cards 101, at least 50 cards 101, and/or more than 50 cards 101. While exercise systems 300 having a plurality of sets of exercise and cooking instructions are described in connection with a set of cards 101, the same can equally be applied to exercise systems composed of a set of pages, a set of posters, screens in a mobile app or computer program, or any other display as described above.

Cards 101 (or other media or device being used to display exercise and cooking instructions according to the present disclosure) can be any size. For example, in some embodiments, each card of the set of cards can be the size of a business card or smaller, the size of an index card or smaller, and/or the size of a standard sheet of letter paper or smaller. In some embodiments, each card of the set of cards (or some of the cards of a set of cards) can have a color-coded portion 134 keyed to the type of food item resulting from the cooking instructions and/or a focus of the exercise instructions. For example, in a given set of cards, those cards having vegetarian recipes may be color-coded in a different color than those cards having non-vegetarian recipes. Similarly, within a set of cards, those containing easy exercises, moderate exercises, and difficult exercises can be color-coded so that the cards having the easy exercises are a first color (or have a first color in the color-coded portion), the cards having the moderate exercises are a second color, and the cards having the difficult exercises are a third color. Other variations of color-coding the cards or other media will be apparent to one of ordinary skill in the art.

Exercise systems of the present disclosure can also be taken a step further, as FIG. 4 shows examples of exercise systems 400, which are examples of the exercise systems 100 of FIGS. 1 and 2, composed of multiple sets of cards 401, 402, 403 (sets of cards 401, 402, and 403 are also examples of exercise systems 100). Each set of cards 401, 402, 403 can be, for example, a set of cards 300 as shown in FIG. 3. Sets of cards 402, and 403 can be composed of the same cards as the set of cards 401, or can be composed of different cards. Any number of sets of cards is possible; while FIG. 4 shows three sets of cards, more or fewer are possible. For example, presently disclosed exercise systems can contain one or more, two or more, three or more, five or more, ten or more, twenty or more, ant/or fifty or more sets of cards. Likewise, each respective set of cards 401, 402, 403 can contain any suitable number of cards 101 (e.g., each set of cards 401, 402, 403 can contain ten or fewer cards 101, twenty or fewer cards 101, fifty or fewer cards 101, and/or more than fifty cards 101).

In some embodiments, each set of cards (e.g., sets of cards 401, 402, 403) in an exercise system 400 can be focused on or directed to one of a plurality of different themes. For example, in exercise systems 400, set of cards 401 may be directed to a theme of Entrees, with each card having a different recipe for a different entrée. As another example, set of cards 402 may be directed to Easy Exercises, with exercise instructions designed for those who are just beginning physical activity or have limited ranges of motion. Other potential themes for sets of cards include Breakfast, Lunch, Dinner. Snacks, Breads, Drinks, Vegan, Vegetarian, Entrees, Gluten-Free, Dairy-Free, Wheat-Free, Sugar-Free, Fat-Free, Reduced Fat, Reduced Sodium, Reduced Cholesterol, Low Fat, Low Calorie, Light, Comfort Food, Pasta, Stir-Fry, Meat and Fish, Rice Dishes, Noodle Dishes, Chinese, Indian, That, Italian, American, Easy, Moderate, Strenuous, Arms, Legs, Back, Abs, Core Strength, Stretching, Strength Training, Flexibility, Balance Training, Aerobic Movement and Exercise, Exercises for Osteoporosis (or any other health condition), Posture Exercises, and Yoga. In other words, themes for a set of cards can be focused on the type of physical activity instructed via the exercise instructions, and/or the type of dish or cuisine taught via the cooking instructions. In some embodiments, a set of cards can have a theme directed to those on a restricted diet, and can contain only recipes that are, for example, gluten-free. Other options for themes include cards with large print for ease of reading. The list of themes given above is non-exclusive, and a set of cards may have one of these themes, any other theme, or no theme at all. As with the cards within a set according to FIG. 3, the sets of cards 401, 402, 403 may be color-coded in some embodiments. For example, a set of cards 401 that primarily includes “easy” exercise instructions may be a first color (e.g., printed on cardstock of a first color, such as blue cardstock such that the background color on one or more surface of the card is blue), a set of cards 402 that primarily includes “moderate” exercise instructions may be a second color, and a set of cards 403 that primarily includes “difficult” exercise instructions may be a third color. Electronic “cards” (e.g., embodiments of exercise systems utilizing electronic or digital media or devices) may be similarly color-coded.

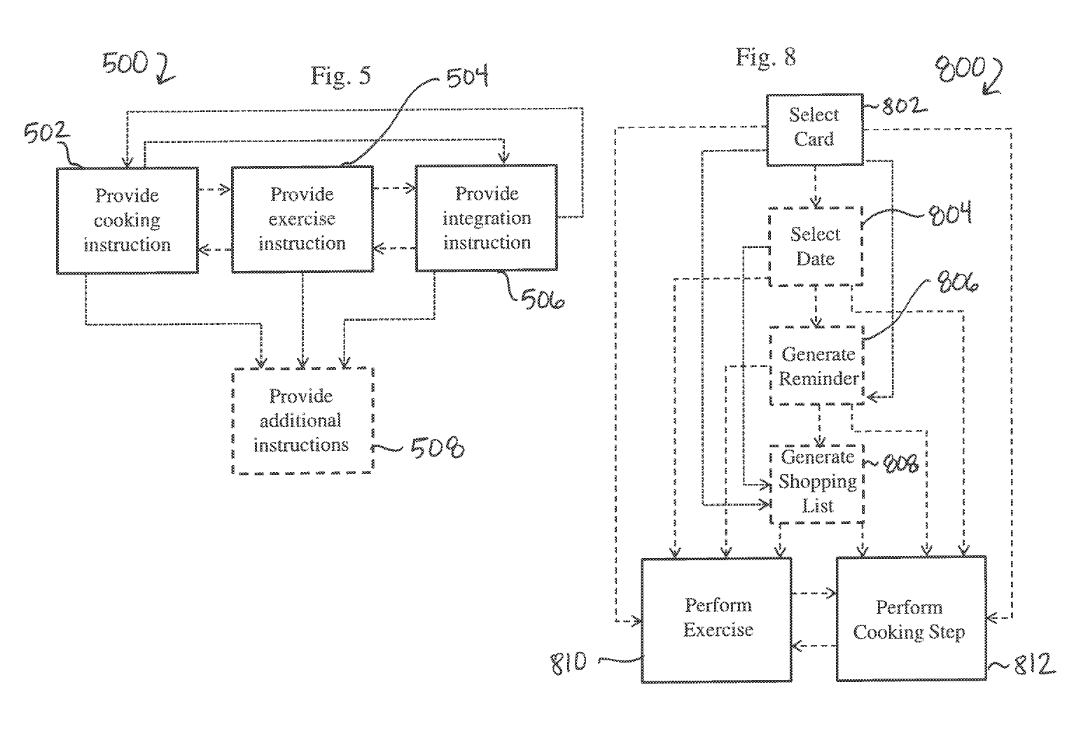

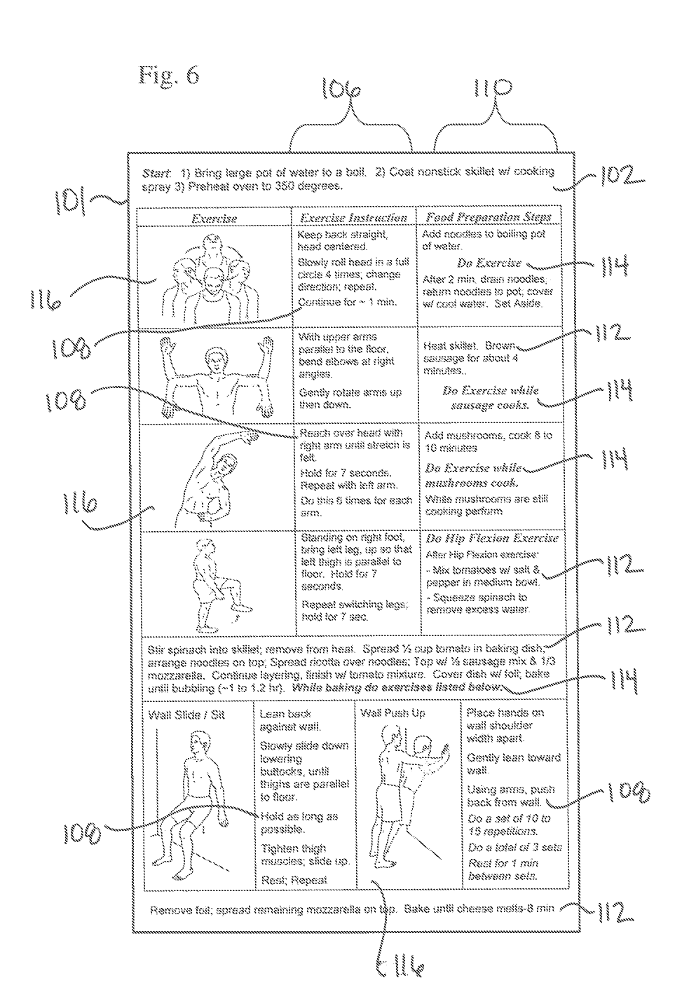

FIG. 5 shows embodiments of methods 500 of providing instructions according to the present disclosure. For example, a first cooking instruction can be provided at 502, a first exercise instruction can be provided at 504, and a first integration instruction can be provided at 506. The first integration instruction can instruct as to when to perform the first exercise instruction with respect to the first cooking instruction and/or vice versa. Providing instructions at 502, 504, and 506 can be performed in any suitable fashion and displayed to a user as described above. For example, instructions can be provided on a printed medium, such as by providing instructions by printing them on the surface of a card or other medium. In other embodiments, instructions can be provided on a digital medium, such as by providing instructions via a computer program, or an app on a mobile device.

In some embodiments, additional instructions can be provided at 508. For example, any number of additional cooking instructions can be provided at 508, as useful for providing instructions regarding the entire preparation of a food item. Any number of additional exercise instructions can be provided at 508, depending on the complexity of the exercises instructed, more or fewer exercise instructions may be provided. Further, in recipes with more down time (e.g., waiting while a food item cooks), more exercise instructions can be provided to occupy that time. Similarly, any number of additional integration instructions can be provided at 508, as useful for instructing when and for how long to perform the exercise instructions with respect to the cooking instructions.

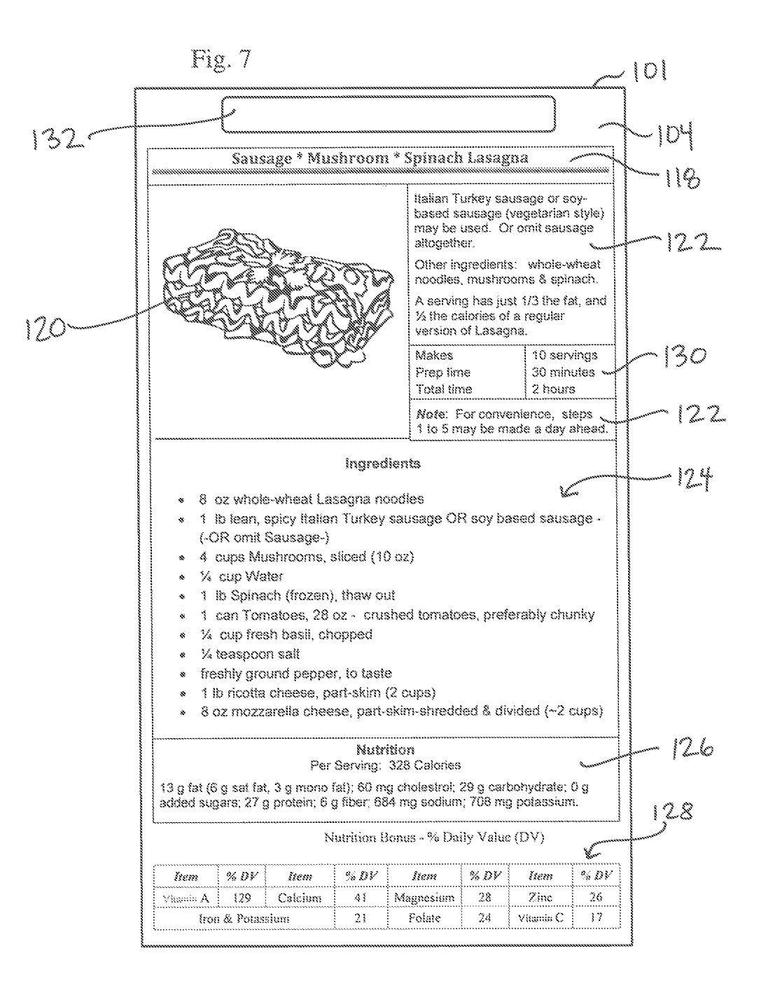

To give some specific context to the methods shown in FIG. 5, FIGS. 6 and 7 show a specific example of an exercise card 101 according to the present disclosure. FIG. 6 shows the front surface 102, having a first display 106 of a plurality of exercise instructions 108 and a second display 110 of a plurality of cooking instructions 112. A plurality of integration instructions 114 are also included that correlate the exercise instructions 108 with the cooking instructions 112. Card 101 can also include a number of images 116 depicting the various exercises and physical activities instructed by the exercise instructions 108. In some embodiments, there can be an image 116 for every exercise instruction 108, or for a group of exercise instructions. In some embodiments, there can be more than one image 116 for every exercise instruction 108 or group of exercise instructions. In some embodiments, some exercise instructions 108 may have a corresponding image 116 and some exercise instructions 108 may not have a corresponding image 116. As shown in FIG. 6, the exercise instructions 108 can include instructions as to the number of sets, the number of reps, and/or the amount of time to hold each position or exercise.

FIG. 7 shows the rear surface 104 of the specific example of card 101 shown in FIG. 6. The rear surface 104 can include information printed thereon pertaining to the food item that results from performance of the cooking instructions 112 on the front surface 102 of card 101. For example, in this specific example, the food item is Sausage Mushroom Spinach Lasagna. The cooking instructions 112 shown in FIG. 6 instruct a user to prepare and cook the food item (Sausage Mushroom Spinach Lasagna) and the rear surface 104 of the card 101 can contain information about the food item, such as the title 118 of the food item, a picture (e.g., drawing or photograph) 120 of the food item, ingredients and needed quantities 124, notes and options 122 for the recipe, information on the recipe yield, points for a weight loss point system, cooking time, preparation time, and/or total time 130, nutritional information 126, and/or vitamin and mineral daily value information 128. A magnet 132 (or a plurality of magnets 132) may also be included on the card 101.

FIG. 8 shows a block diagram of embodiments of a method 800 of using an exercise system according to the present disclosure. A card can be selected from a set of cards (or other media) at 802. If a user is planning ahead and selecting the card for performance on a future date, the user can select a date for performance of the card at 804. For example, a user can assign a date to a card or recipe using a computer, a calendar, a mobile device, an app for a mobile device, a web site, or in any other suitable fashion. In some embodiments, the exercise system can automatically generate a reminder at 806 and/or automatically generate a shopping list for required ingredients at 808, immediately upon selection of the card at 802 and/or at a later time, as selected by the user. Once the user is ready to perform the instructions provided on the selected card and has acquired the needed ingredients, the user can perform the exercise instructions at 810 and perform the cooking instructions at 812, in accordance with the card or other exercise system format, generally following the cooking instructions in chronological order as presented, and performing the exercise instructions during cooking, as instructed by the integration instructions. A user can perform all or some of the exercise instructions on a given card.

While the specific examples given are focused on integrating physical activity or exercise with food preparation, the concepts disclosed herein are generally applicable in other areas as well. For example, other embodiments of exercise systems may provide exercise instructions and integration instructions that correlate to other activities besides cooking, such as other household chores (e.g., cleaning, doing laundry), watching television, sitting at a desk, or etc.

Illustrative, non-exclusive examples of exercise systems, sets of cards, and method of providing instructions according to the present disclosure are described in the following enumerated paragraphs:

A1. An exercise system, comprising:

a first display displaying a plurality of exercise instructions;

a second display displaying a plurality of cooking instructions; and

a plurality of integration instructions, wherein each of the plurality of integration instructions instructs as to when to perform each of the plurality of exercise instructions with respect to a respective one or more of the plurality of cooking instructions.

A2. The exercise system of paragraph A1, wherein the first display comprises a card with the plurality of exercise instructions printed thereon.

A3. The exercise system of paragraph A1 or A2, wherein the first display comprises a set of cards with the plurality of exercise instructions printed thereon.

A4. The exercise system of any of paragraphs A1-A3 wherein the second display comprises a card with the plurality of cooking instructions printed thereon.

A5. The exercise system of any of paragraphs A1-A4, wherein the second display comprises a set of cards with the plurality of cooking instructions printed thereon.

A6. The exercise system of any of paragraphs A1-A5, wherein the first display and the second display are printed on a front surface of a card.

A7. The exercise system of paragraph A6, wherein the card comprises a rear surface opposite the front surface, and wherein the rear surface contains recipe information printed thereon.

A8. The exercise system of paragraph A7, wherein the recipe information comprises one or more of ingredients, serving size, nutritional information, yield, points for a weight loss point system, cooking time, total time, and preparation time.

A9. The exercise system of any of paragraphs A1-A8, wherein the first display comprises one or more of a card (or a portion thereof), a page (or a portion thereof), a sheet (or a portion thereof), a poster (or a portion thereof), a book (or a portion thereof), a binder (or a portion thereof), a digital file (or a portion thereof), a computer monitor, a mobile phone, and an app for a mobile device.

A10. The exercise system of any of paragraphs A1-A9, wherein the second display comprises one or more of a card (or a portion thereof), a page (or a portion thereof), a sheet (or a portion thereof), a poster (or a portion thereof), a book (or a portion thereof), a binder (or a portion thereof), a digital file (or a portion thereof), a computer monitor, a mobile phone, and an app for a mobile device.

A11. The exercise system of any of paragraphs A1-A10, wherein the exercise system is configured to send a reminder to a user to utilize the exercise system.

A12. The exercise system of any of paragraphs A1-A11, wherein the exercise system is configured to automatically generate a shopping list corresponding to the plurality of cooking instructions.

A13. The exercise system of any of paragraphs A1-A12, wherein the exercise system is integrated with a calendar.

A14. The exercise system of any of paragraphs A1-A13, wherein the exercise system comprises a set of a plurality of cards, each card of the plurality of cards comprising a respective first display directed to a respective set of exercise instructions and a respective second display directed to a respective set of cooking instructions, each respective set of cooking instructions being different from every other respective set of cooking instructions.

A15. The exercise system of paragraph A14, wherein the exercise system comprises a plurality of sets of cards, each of the sets of cards being directed to one of a plurality of different themes.

A16. The exercise system of paragraph A15, wherein the plurality of different themes comprise one or more of Breakfast, Lunch, Dinner, Snacks, Breads, Drinks, Vegan, Vegetarian, Entrees, Gluten-Free, Dairy-Free, Wheat-Free, Sugar-Free, Fat-Free, Reduced Fat, Reduced Sodium, Reduced Cholesterol, Low Fat, Low Calorie, Light, Comfort Food, Pasta, Stir-Fry, Meat and Fish, Rice Dishes, Noodle Dishes, Chinese, Indian, That, Italian, American, Easy, Moderate, Strenuous, Arms, Legs, Back, Abs, Core Strength, Stretching, and Yoga.

B1. A set of cards, each card of the set of cards comprising:
a first surface on which instructional material is printed, wherein the instructional material comprises a plurality of cooking instructions for making a food item and a plurality of exercise instructions, the cooking instructions and exercise instructions being integrated and correlated together to provide a step-by-step guide configured to instruct performance of the exercise instructions during performance of the cooking instructions; and
a second surface on which informational material is printed, wherein the informational material comprises informational material pertaining to the food item.

B2. The set of cards of paragraph B1, wherein the informational material comprises one or more of the food item title, options and substitutions for making the food item, serving size, recipe yield, total time, cooking time, preparation tune, ingredients, ingredient quantities, and nutritional information pertaining to the food item.

B3. The set of cards of paragraph B1, wherein the informational material comprises the food item title, options and substitutions for making the food item, serving size, recipe yield, total time, cooking time, preparation time, ingredients, ingredient quantities, and nutritional information pertaining to the food item.

B4. The set of cards of any of paragraphs B1-B3, wherein the instructional material comprises one or more images depicting one or more exercises to be performed.

B5. The set of cards of any of paragraphs B1-B4, wherein the set of cards comprises a first card, a second card, a third card, and so on, wherein the instructional material printed on the first card comprises cooking instructions for making a first food item, wherein the instructional material printed on the second card comprises cooking instructions for making a second food item, the second food item being different from the first food item, wherein the instructional material printed on the third card comprises cooking instructions for making a third food item, wherein the third food item is different from the second food item and different from the first food item, so that the instructional material printed on each respective card comprises different respective cooking instructions for making a different respective food item.

B6. The set of cards of any of paragraphs B1-B5, wherein each card of the set of cards is magnetic.

B7. The set of cards of any of paragraphs B1-B6, wherein each card of the set of cards comprises a magnetic portion.

B8. The set of cards of any of paragraphs B1-B7, wherein each card of the set of cards has a color-coded portion, the color-coded portion being keyed to the type of food item resulting from the cooking instructions and/or a body area focus of the exercise instructions.

B9. The set of cards of any of paragraphs B1-B8, wherein each card of the set of cards is the size of a business card or smaller, the size of an index card or smaller, and/or the size of a standard sheet of letter paper or smaller.

C1. A method of providing instructions, comprising:

providing a first cooking instruction;

providing a first exercise instruction; and

providing a first integration instruction, wherein the first integration instruction instructs as to when to perform the first exercise instruction with respect to the first cooking instruction.

C2. The method of paragraph C1, wherein one or more of the providing the first cooking instruction, the providing the first exercise instruction, and the providing the first integration instruction comprises providing the same on a printed medium.

C3. The method of any of paragraphs C1 or C2, wherein one or more of the providing the first cooking instruction, the providing the first exercise instruction, and the providing the first integration instruction comprises providing the same on a digital medium.

C4. The method of any of paragraphs C1-C3, wherein the providing the first cooking instruction comprises providing a plurality of cooking instructions, performance of which results in completion of cooking a food item, wherein the providing the first exercise instruction comprises providing a plurality of exercise instructions, and wherein the providing the first integration instruction comprises providing a plurality of integration instructions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including inure than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, C” and “A, B, and/or C” may mean A alone, B alone, C alone, A and B together, A and C together, B and C together, k, B and C together, and optionally any of the above in combination with at least one other entity.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Also within the scope of the present disclosure are computer-readable storage, or memory, media suitable for storing computer-executable instructions, or software, for implementing methods and exercise systems according to the present disclosure. Examples of such media include CD-ROMs, disks, hard drives, etc. such as may include software for transferring and/or downloading to a mobile computing device. As used herein, storage, or memory, devices and media having computer-executable instructions, as well as mobile-computing device implemented methods, server implemented methods, computer implemented methods, and other methods according to the present disclosure are considered to be within the scope of subject matter deemed patentable in accordance with the national laws of the country in which this patent application is pending, such as (but not limited to) Section 101 of Title 35 of the United States Code.

The disclosure set forth above encompasses multiple distinct inventions with independent utility. While each of these inventions has been disclosed in a preferred form or method, the specific alternatives, embodiments, and/or methods thereof as disclosed and illustrated herein are not to be considered in a limiting sense, as numerous variations are possible. The present disclosure includes all novel and non-obvious combinations and subcombinations of the various elements, features, functions, properties, methods and/or steps disclosed herein. Similarly, where any disclosure above or claim below recites “a” or “a first” element, step of a method, or the equivalent thereof, such disclosure or claim should be understood to include one or more such elements or steps, neither requiring nor excluding two or more such elements or steps.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application, Such amended or new claims, whether they are directed to a different invention or directed to the same invention, whether different, broader, narrower, or equal in scope to the original claims, are also regarded as included within the subject matter of the inventions of the present disclosure.

1. An exercise system, comprising:
a first display displaying a plurality of exercise instructions;
a second display displaying a plurality of cooking instructions; and
a plurality of integration instructions displayed by at least one of the first display and the second display, wherein the integration instructions instruct as to when to perform each of the plurality of exercise instructions with respect to a respective one or more of the plurality of cooking instructions.

2. The exercise system of claim 1, wherein the first display comprises a card with the plurality of exercise instructions printed thereon.

3. The exercise system of claim 2, wherein the first display comprises a set of cards and the plurality of exercise instructions comprises a respective set of the plurality of exercise instructions, each respective set of the plurality of exercise instructions being printed on a respective card of the set of cards.

4. The exercise system of claim 1, wherein the second display comprises a card with the cooking instructions printed thereon.

5. The exercise system of claim 4, wherein the second display comprises a set of cards and the plurality of cooking instructions comprises a respective set of the plurality of cooking instructions, each respective set of the plurality of cooking instructions being printed on a respective card of the set of cards.

6. The exercise system of claim 1, further comprising a card comprising a front surface and a rear surface, wherein the first display and the second display are printed on the front surface of the card.

7. The exercise system of claim 6, wherein the rear surface of the card contains recipe information printed thereon.

8. The exercise system of claim 7, wherein the recipe information comprises one or more of ingredients, serving size, nutritional information, yield, points for a weight loss point system, cooking time, total time, and preparation time.

9. The exercise system of claim 1, wherein the first display comprises one or more of at least a portion of a card, at least a portion of a page, at least a portion of a sheet, at least a portion of a poster, at least a portion of a book, at least a portion of a binder, at least a portion of a digital file, at least a portion of a view on a computer monitor, a mobile phone, and an app for a mobile device.

10. The exercise system of claim 1, wherein the second display comprises one or more of at least a portion of a card, at least a portion of a page, at least a portion of a sheet, at least a portion of a poster, at least a portion of a book, at least a portion of a binder, at least a portion of a digital file, at least a portion of a view on a computer monitor, a mobile phone, and an app for a mobile device.

11. The exercise system of claim 1, wherein the exercise system is configured to send a reminder to a user to utilize the exercise system.

12. The exercise system of claim 1, wherein the exercise system is configured to automatically generate a shopping list corresponding to the plurality of cooking instructions.

13. The exercise system of claim 1, wherein the exercise system is integrated with a calendar.

14. The exercise system of claim 1, wherein the exercise system comprises a set of a plurality of cards, each card of the plurality of cards comprising a respective first display directed to a respective set of exercise instructions and a respective second display directed to a respective set of cooking instructions, each respective set of cooking instructions being different from every other respective set of cooking instructions.

15. The exercise system of claim 14, wherein the exercise system comprises a plurality of sets of cards, each of the sets of cards being directed to one of a plurality of different themes.

16. The exercise system of claim 15, wherein the plurality of different themes comprise one or more of Breakfast, Lunch, Dinner, Snacks, Breads, Drinks, Vegan, Vegetarian, Entrees, Gluten-Free, Dairy-Free, Wheat-Free, Sugar-Free, Fat-Free, Reduced Fat, Reduced Sodium, Reduced Cholesterol, Low Fat, Low Calorie, Light, Comfort Food, Pasta, Stir-Fry, Meat and Fish, Rice Dishes, Noodle Dishes, Chinese, Indian, That, Italian, American, Easy, Moderate, Strenuous, Arms, Legs, Back, Abs, Core Strength, Stretching, and Yoga.

17. A method of providing instructions, comprising:
providing a first cooking instruction;
providing a first exercise instruction; and
providing a first integration instruction, wherein the first integration instruction instructs as to when to perform the first exercise instruction with respect to the first cooking instruction.

18. The method of claim 17, wherein one or more of the providing the first cooking instruction, the providing the first exercise instruction, and the providing the first integration instruction comprises providing the same on a printed medium.

19. The method of claim 17, wherein one or more of the providing the first cooking instruction, the providing the first exercise instruction, and the providing the first integration instruction comprises providing the same on a digital medium.

20. The method of claim 17, wherein the providing the first cooking instruction comprises providing a plurality of cooking instructions, performance of which results in completion of cooking a food item, wherein the providing the first exercise instruction comprises providing a plurality of exercise instructions, and wherein the providing the first integration instruction comprises providing a plurality of integration instructions.
